(19) United States
(12) Patent Application Publication
(10) Pub. No.: US 2013/0000933 A1
(43) Pub. Date: Jan. 3, 2013

(54) Method and apparatus for adapting an output of a drive unit to accommodate a changing load in a cyclic action upon material

(75) Inventor: Jiri Neuwirth, Zlin (CZ)

(73) Assignee: WISTA S.R.O., Zlin (CZ)

(21) Appl. No.: 13/533,960

(22) Filed: Jun. 26, 2012

(30) Foreign Application Priority Data
Jun. 28, 2011 (CZ) PV 2011-385

(51) Int. Cl. B23Q 5/00

(52) U.S. Cl. 173/1; 173/141

(57) ABSTRACT

A drive unit has an output subject to changing loads, where the drive unit consists of fixed and moving parts connected to a power source. The output of the drive unit is controlled in cycles, and for ascertaining the load in a given cycle, the time period required for changing the position of the moving part of the drive unit, or for changing the position of the moving part of the equipment in mechanical contact with the moving part of the drive unit, from one predefined position to another predefined position is measured, whereby the input required in the next cycle is determined according to the time period ascertained in at least one preceding cycle. Where the drive unit is an electric motor, the input required in given cycle is also determined according to electric resistance of the electric motor ascertained in at least one preceding cycle.

The invention concerns adapting of the output of a drive unit to a changing load by control of the input of the drive unit, which is used, for instance, to drive a rake conveyor or other equipment for transport of loose materials, or other equipment where under rising load at stable input, the output declines. The invention optimizes equipment output by regulation of the input of the drive unit in relation to the momentarily required output for the purpose of saving energy and reducing wear of the moving components.

### BACKGROUND

When a drive unit operates upon a load, it often happens that when the load increases (with the drive unit having a constant input), the equipment slows down. Often it is undesirable that the equipment slows down. The crude way to solve this problem, and indeed the way most often employed in practice, is to throw money and power at the problem, by feeding more power to the drive unit at all times. This wastes power during the times when the load is not so great, and it causes the drive unit to wear faster. In the chief examples given here, the drive unit is connected with equipment acting upon material, such as a system of rakes, and the solution of feeding more power to the drive unit at all times also causes unneeded wear and tear upon the equipment that acts upon the material.

In the chief examples given here, the overall goal is efficient transport of loose materials by means of a conveyor. Typical conveyors are vibration, screw, rake and belt conveyors. The conveyors have pneumatic, hydraulic or electric drive units. Typical known drive units of typical conveyors have a stable, constant output. The disadvantage of such conveyors is that during operation their actual state does not reflect their load. If at a particular moment there is more material to be transported, the result is that the speed of the conveyor drops, and thus its effective output is reduced.

In some plants the volume of material to be transported can change substantially from time to time. In a typical known system with a drive unit of a particular size, the drive unit powered with a particular level of power, a momentary overload of the conveyor (because of a momentary substantial increase the amount of material to be conveyed) may even lead to its failure. In the prior art, a typical way to attempt to prevent such failure is to “over-engineer” the conveyor, dimensioning the conveyor for higher throughput so that it is suitable for the highest possible load. When such an over-engineering approach is employed, then during the more nearly average operating conditions, at lower loads, there is incessant motion of the moving components. The consequence is higher energy consumption and excessive wear of the moving components.

The alert reader will by now have appreciated that it would be very helpful if an approach could be found that would reduce or eliminate the problem of a material-transport system slowing down when a load increases, while avoiding the need to over-engineer a conveyor employed in the system, all in way that minimizes excessive wear and tear on moving components, minimizes power consumption, and does not cost too much money.

### SUMMARY OF THE INVENTION

The drive unit consists of a fixed part and moving part and is connected to an power source, whereby the output of the drive unit is controlled in cycles is, that for the purpose of ascertaining the load in a given cycle, time period required for changing position of the moving part of the drive unit or for changing position of moving part of the equipment, which is in mechanical contact with the moving part of the drive unit from one predefined position to the another predefined position is measured. The input for the drive unit required in the next cycle is determined according to the time period, ascertained in at least one preceding cycle. In the case of a pneumatically controlled drive unit, its input is controlled by regulation of the flow and/or by selection of pressure of driving gas, used for the pneumatically controlled drive unit. In case of the hydraulically controlled drive unit, its input is controlled by regulation of the flow of the hydraulic fluid and/or by pressure acting on the hydraulic fluid. In the case of a pneumatically or hydraulically controlled drive unit, it is alternatively possible to ascertained its load in a given cycle, the pressure of the gas or hydraulic fluid is also ascertained, at least at one point between the gas source or hydraulic fluid source and the piston of the drive unit, preferably in the gas supply pipe before the input/output of the drive unit, whereby the input of the drive unit for the next cycle is also determined based on the pressure ascertained in the preceding cycle. According to the alternative with an electric motor, it is possible when ascertaining the load in a given cycle, the electric resistance of the electric motor is also ascertained, whereby the input of the electric motor for the next cycle is also set based on the electric resistance of the electric motor, which is ascertained in the preceding cycle.

Adapting of the output of the drive unit to changing load, where the drive unit consists of a fixed part and a moving part and at least one input/output, is via a regulating and/or switching element connected to at least one power source is that it further includes the control unit, whose control output is connected to the control input of the regulating and/or switching element. Also provided is at least one sensor for indication of the presence of at least two indication points or at least two sensors for indication of the presence of at least one indication point, where at least one indication point is located on the moving part of the drive unit or on the moving part of the equipment, which is mechanically connected to the moving part of the drive unit. The output of the at least one sensor of the indication point is connected to an input of the control unit.

Alternatively the power source is a source of compressed gas. According to another alternative the power source is a source of hydraulic fluid or source of electric power. The apparatus may also contain at least one pressure sensor in the pipe between the power source and the input/output of the drive unit, whereby the pressure sensor has an output that is provided to the control unit. According to another alternative connection there is a selector for selecting among two or more power sources, the selector connected between the regulating and/or switching element and at least two power sources, whereby the output of the element for selection of power source is connected to the input of the regulating or switching element that has at least one input is connected to output of at least one of two power sources. The selector has a control input, connected to an appropriate control output of the control unit.

The alert reader will appreciate that this approach can save energy. In an actual case implemented by the inventor relating to a rake conveyor, this energy saving is up to 50%. The reader will also appreciate that for much of the operating time, the motion frequency of the moving parts can be reduced, and this of course reduces their wear. This is manifest in longer service life of the moving parts of the equipment.

The output of the drive unit (1) is controlled with respect to cycles that happen one after another. The determination of the input essential for the next cycle is done in one of the preceding cycles, drawing upon measurement of the period required by the moving part (12) of the drive unit (1) or moving part (751) of the equipment, which is mechanically connected to the moving part (12) of the drive unit (1), for change of position from one predefined position to another predefined position. In the case of a pneumatic drive unit (1), the input is controlled by regulation of the flow and/or selection of gas pressure. In case of a hydraulic drive unit (1), the input is controlled by regulation of the hydraulic fluid flow and/or pressure of the hydraulic fluid acting on the drive unit and in case of an electric drive unit (1), its input is controlled by means of higher level or variation of the power supply voltage. When setting the input for the next cycle, it is possible in the case of the pneumatic and hydraulic drive units to also consider the pressure, at least, at one point of the supply pipe, ascertained in one of the previous cycles. In the case of an electric drive unit, the electric resistance ascertained in one of the preceding cycles is used to pick a power level provided to the drive unit in a present cycle.

Drive unit (1) contains a moving part (12) and at least one input/output (13,14), which is connected via a regulating and/or switching element (61) connected to at least one power source (91). The system also includes a control unit (5) whose control output (55, 56) is connected to a control input (631, 632) of a regulating and/or switching element (61) and at least one sensor (71, 72) of the position for detection of the presence of at least two indicating points (19,39) or at least two sensors (71, 72) for detection of the presence of at least one indicating point (19), where the indication point is on the moving part (12) of the drive unit (1) or on the moving part (751) of the equipment (75), which is mechanically connected to the moving part (12) of the drive unit (1). The output (711, 721) of at least one position sensor (71, 72) is connected to the input (51,52) of the control unit (5). The power source (91) may be a source of compressed gas, source of hydraulic fluid or electric power. The connection may further contain at least one pressure sensor (94, 96) connected to the control unit (5). Further the connection may contain at least one element for selection of power source controlled by the control unit (5).

### DESCRIPTION OF THE DRAWINGS

FIG. 1 shows an embodiment according to example 1 in a state where the rakes of the first rake conveyor push the transported loose material over and the rakes of the second rake conveyor return to initial position.

FIG. 2 shows an embodiment according to example 2 and

FIG. 3 shows an embodiment according to example 3.

FIGS. 4 and 5 show an embodiment according to example 4, wherein FIG. 4 shows the presence of the first indication point indicated by the sensor and FIG. 5 shows the presence of the second indication point indicated by the sensor.

### DETAILED DESCRIPTION OF THE INVENTION

Several examples will help the reader to understand the invention and to appreciate ways in which the invention may be implemented. Each of these examples will help the reader to appreciate that any of several structures may be employed to bring about particular limitations of the claimed invention.

### Example 1

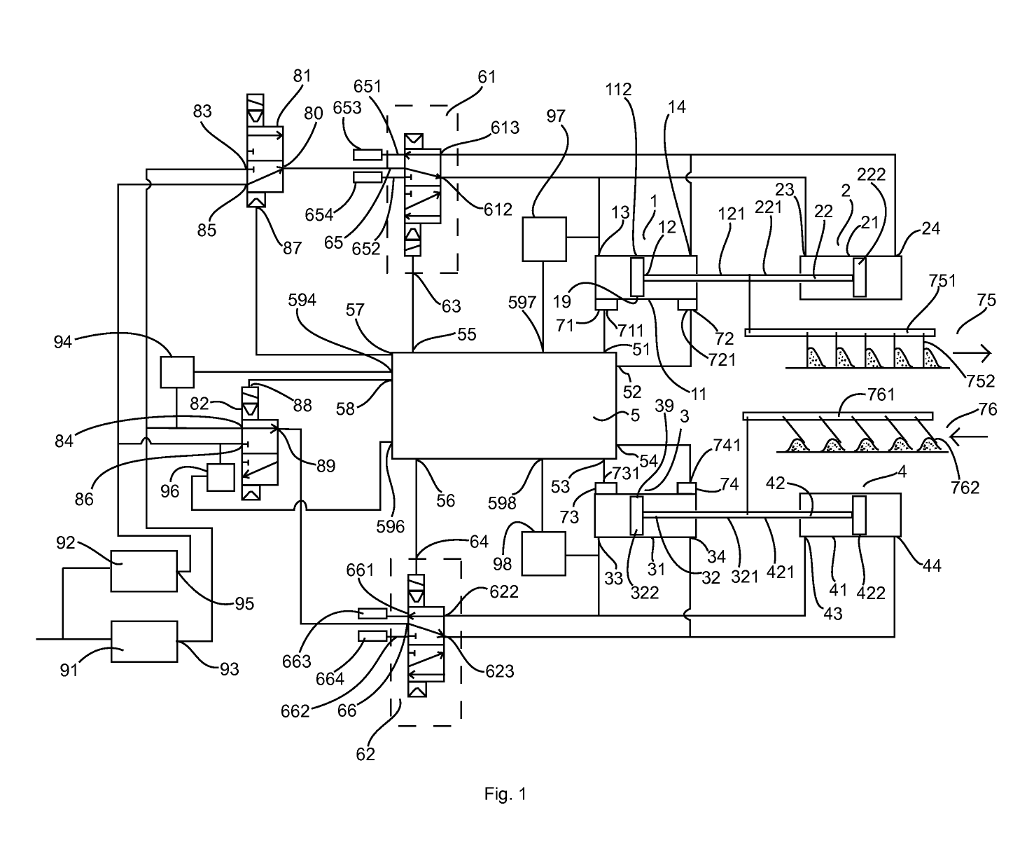

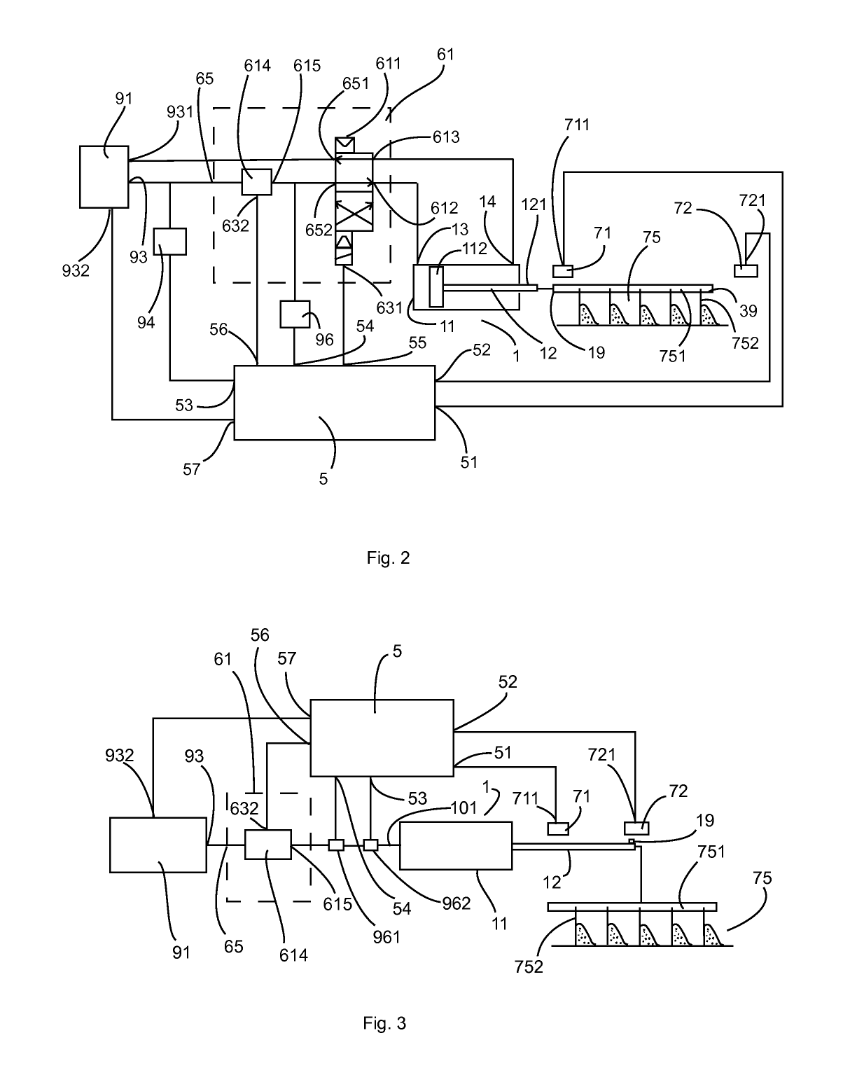

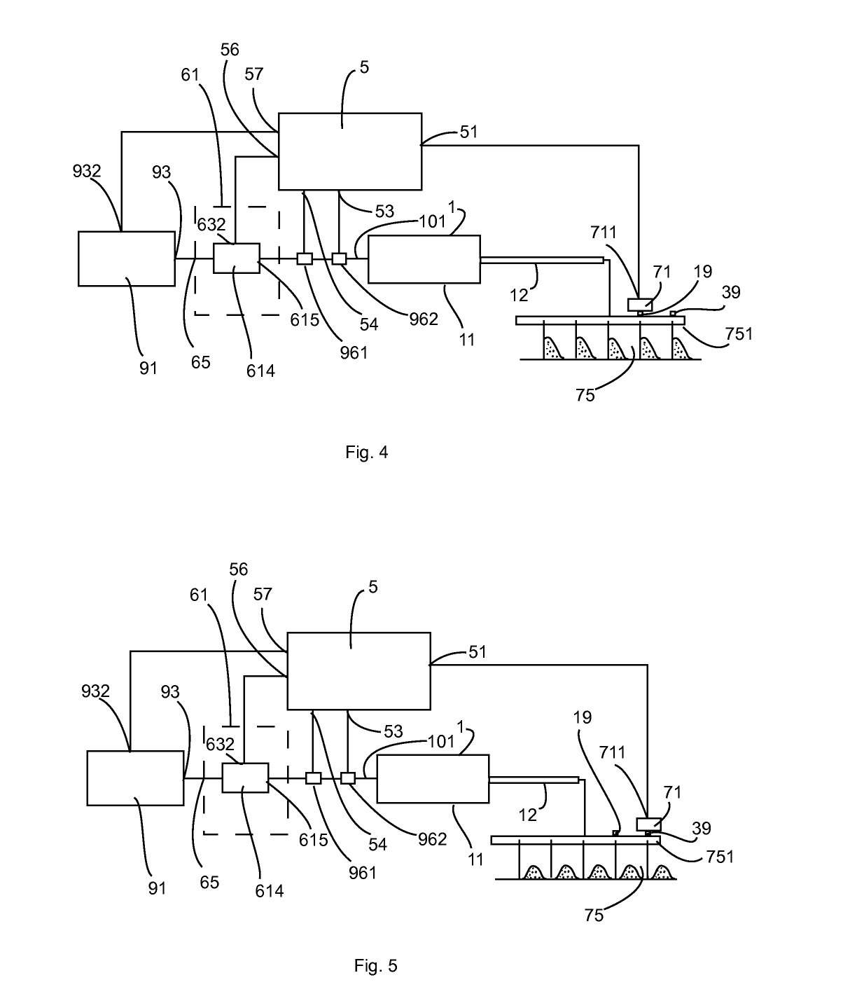

In this example, abrasive blasting is employed to clean surfaces of items. The items being cleaned may be items recently cast, for example, or items recently molded or machined. At a work station, used abrasive and released dirt fall downward, through a grille. These materials need to be transported laterally to a place where the materials can be acted upon so that the abrasive may be reused. The lateral transport of the materials is a chief focus of the discussion which follows, and in this example is accomplished by means of rake conveyors 75, 76 in FIG. 1.

The reader, after reading the discussion which follows, will appreciate that the benefits of the invention offer themselves not only in the specific case where the conveyor is a rake conveyor of the type appearing in the figure, but also where other types of conveyors are employed.

According to example 1 the connection for adaptation of the output of drive unit 1,2,3,4 to the changing loads is exercised at the station for cleaning of the surfaces of the abrasive blasted items. The station has two rake conveyors 75,76 for removal of used abrasive and released dirt being settled under the grille, which makes up the station. Rake conveyors 75,76 are driven by drive units 1,2,3,4. The rake conveyors 75,76 contain moving parts 751, 761 with suspended rakes 752, 762. The moving parts 751,761 of rake conveyors 75,76 are in mechanical contact with the moving parts 12,22,32,42 of drive units 1,2,3,4. The first rake conveyor 75 is driven by the first drive unit 1 and the second drive unit 2, which are opposite each other. The second rake conveyor 76 is driven by the third drive unit 3 and the fourth drive unit 4, which are also opposite each other. Each of the drive units 1,2,3,4 consists of a dual-action pneumatic linear motor having fixed part 11, 21, 31, 41 and moving part 12, 22, 32, 42. As illustrated, the moving part 12, 22, 32, 42 of each drive unit 1,2,3,4 consists of a piston 112, 222, 322, 422 and piston rod 121, 221, 321, 421. The fixed part 11, 21, 31, 41 of each drive unit 1,2,3,4 contains a pneumatic cylinder with two inputs/outputs 13, 14, 23, 24, 33, 34, 43, 44, whereby two inputs/outputs 13, 14, 23, 24, 33, 34, 43, 44, which are related to the same drive unit 1, 2, 3, 4 are found on opposite ends of the piston 112, 222, 322, 422 of the given drive unit 1, 2, 3, 4. The first and second drive unit 1,2 are mutually connected via their piston rods 121, 221. The piston rods 121, 221 of the first and second drive units 1, 2 are further connected with the moving part 751 of the first rake conveyor 75 with which it is mechanically connected. Also the third and fourth drive units 3,4 are connected by their piston rods 321, 421. The piston rods 321, 421 of the third and fourth drive units 3,4 are further connected with the moving part 761 of the second rake conveyor 76 with which they are mechanically connected. Pistons 112 and 322 of the first and third drive units 1,3 have magnetic parts formed in or upon them. The magnetic part of piston 112 of the first drive unit 1 is the first indication point 19 for indication of the position of moving part 12 of the first drive unit and moving part 22 of the second drive unit 2. The magnetic part of piston 322 of the third drive unit 3 is the second indication point 39 for indication of the position of moving part 32 of the third drive unit 3 and moving part 42 of the fourth drive unit 4. The fixed parts 11, 31 of the first and third linear drive units 1, 3 are fitted by have sensors 71, 72, 73, 74. The first and the second sensors 71, 72 are used to indicate the presence of the first indication point 19. The third and the fourth sensors 73, 74 are used to indicate the presence of the second indication point 39. Each of the sensors 71, 72, 73, 74 of any of the indicating points 19,39 has output 711, 721, 731, 741 and according to this example consist of a magnetically controlled electric switch for detection of the presence of the magnetic piston near sensor 71, 72, 73, 74. The first sensor 71 is situated near the base of the cylinder, which is opposite to the base of the cylinder, which houses piston rod 121 of moving part 12 of the first linear drive 1. The second sensor 72 is on the opposite side of the cylinder near the base of the cylinder, which houses piston rod 121 of moving part 12 of the same linear drive 1. The third sensor 73 is near the base of the cylinder, which is opposite to the base of the cylinder, which houses piston rod 321 of moving part 32 of the third linear drive 3 and fourth sensor 74 is located on the opposite side of the same cylinder, close to the base of the cylinder, which houses piston rod 321 of moving part 32 of the third linear drive 3. The equipment further includes two power sources 91,92. According to this example, compressed air power is used. The first power source 91 has an output compressed air pressure of 0.2 MPa, the second power source 92 has a an output compressed air pressure of 0.5 MPa. An integral part of the connection for control of the drive units 1,2,3,4 are also two elements 81,82 for selection of power source 91,92, two regulating and/or switching elements 61,62, control unit 5 and four pressure sensors 94,96,97,98. The connections incorporate inputs/outputs 13,14,23,24,33,34,43,44 of the fixed parts of the drive units 1,2,3,4 through the regulating and/or switching elements 61,62 and through elements 81, 82 for selection of power source 91, 92 connected to power sources 91, 92. The first regulating and/or switching element 61 includes an input 65, two outputs 651, 652, two inputs/outputs 612,613 and control input 631. Input 65 of the first regulating and/or switching element 61 is connected through the first element 81 for selection of power source 91, 92 to power source 91,92. To both outputs 651,652 are connected noise dampeners 653,654, which dampen the noise from release of used air to the atmosphere. The first input/output 612 of the first regulating and/or switching element 61 is connected to the first input/output 13 of the first drive unit 1 and the first input/output 23 of the second drive unit 2. The second input/output 613 of the first regulating and/or switching element 61 is connected to the second input/output 14 of the first drive unit 1 and the second input/output 24 of the second drive unit 2. The second regulating and/or switching element 62 includes input 66, two outputs 661, 662, two inputs/outputs 622,623 and control input 64. Input 66 of the first regulating and/or switching element 62 is connected through the second element 82 for selection of power source 91, 92 to power source 91,92. To both outputs 661,662 are connected noise dampeners 663,664, which dampen the noise from release of used air to the atmosphere. The first input/output 622 of the second regulating and/or switching element 62 is connected to the first input/output 33 of the third drive unit 3 and the first input/output 43 of the fourth drive unit 4. The second input/output 623 of the second regulating and/or switching element 62 is connected to the second input/output 34 of the third drive unit 3 and the second input/output 44 of the fourth drive unit 4. The first element 81 for selection of power source 91, 92 is connected between the first regulating and/or switching element 61 and both power sources 91,92 and the second element 81 for selection of power source 91, 92 is connected between the second regulating and/or switching element 61 and both power sources 91,92. Output 80 of the first element 81 for selection of power source 91, 92 is connected to input 65 of the first regulating or switching element 61 and output 89 of the second element 82 for selection of power source 91, 92 is connected to output 66 of the second regulating or switching element 62. The first input 83 of the first element 81 for selection of power source 91, 92 and first input 84 of the second element 82 for selection of power source 91, 92 are connected with output 93 of the first power source 91 and the second input 85 of the first element 81 for selection of the power source 91, 92 and second input 86 of the second element 82 for selection of the power source 91, 92 are connected to the output 95 of the second power source 92. The first element 81 for selection of the power source 91,92 has a control input 87 and the second element 82 for selection of power source 91,92 has a control input 88. The first pressure sensor 94 is located in the part of the pipe that connects output 93 of the first power source 91 with the first input 84 of the second element 82 for selection of the power source 91, 92 and with the first input 83 of the first element 81 for selection of the power source 91, 92. The second pressure sensor 96 is located in the part of the pipe that connects output 95 of the second power source 92 with the second input 86 of the second element 82 for selection of the power source 91, 92 and with the second input 85 of the first element 81 for selection of the power source 91, 92. The third pressure sensor 97 is located in that part of the pipe, which connects the first input 13 of the first drive unit 1 with the first regulating and/or switching element 61 and the fourth pressure sensor 98 is located in that part of the pipe that connects the first input/output 33 of the third drive unit 3 with the second regulating and/or switching element 62. All the pressure sensors 94,96,97,98 are further connected with control unit 5. Output 711 of the first sensor 71 of the first indicating point 19 is connected with the first input 51 of the control unit 5, output 721 of the second sensor 72 of the first indicating point 19 is connected with the second input 52 of the control unit 5. Output 731 of the third sensor 73 of the second indicating point 39 is connected with the third input 53 of the control unit 5 and output 741 of the fourth sensor 74 of the second indicating point 39 is connected with the fourth input 54 of the control unit 5. The first pressure sensor 94 is connected with the fifth input 594 of the control unit 5, the second pressure sensor 96 is connected with the sixth input 596 of the control unit 5, the third pressure sensor 97 is connected with the seventh input 597 of the control unit 5 and fourth pressure sensor 98 is connected with the eighth input 598 of the control unit 5. Control unit 5 further includes the first control output 55, connected with the control input 63 of the first regulating and/or switching element 61, second control output 56 connected with control input 64 of the second regulating and/or switching element 62, third control output 57 connected with the control input 87 of the first element 81 for selection of power source 91,92 and fourth control output 58 connected with control input 88 of the second element 82 for selection of power source 91,92.

The alert reader will appreciate, after reading the discussion of this example as well as the discussion of example 2 below, that one way to sense movement of the laterally moving parts is to provide two magnets and one sensor, or to provide one magnet and two sensors. With either structure the control means is able to ascertain the amount of time required for the laterally moving parts to move from one extreme position to the other extreme position. The more general term “sensor arrangement” may be helpful to encompass the variety of structures which the alert reader might devise to measure this amount of time.

As will be appreciated after the detailed discussion which follows, a most general characterization of the control approach is this. When the measured time interval during a cycle is shorter, probably there is less material needing to be conveyed, meaning that there is less of a load on the drive means. When this happens then during a subsequent cycle the control means can provide relatively less power to the drive means (for example the lower-power source 93 can be used). When the measured time interval during a cycle is longer, probably there is more material needing to be conveyed, meaning that there is more of a load on the drive means. When this happens then during a subsequent cycle the control means can provide relatively more power to the drive means (for example the higher-power source 95 can be used).

In the simplest case a measured time interval during a particular cycle can be employed to make a decision as to the power level to be provided to the drive means during the immediately subsequent cycle. In a more sophisticated case the power level to be provided to the drive means during a present cycle may be chosen based upon information gathered during some cycle that is further in the past than the immediately previous cycle. In an even more sophisticated case the power level to be provided to the drive means during a present cycle may be chosen based upon information gathered during several previous cycles, for example by averaging the measured time intervals during those several previous cycles. (Such averaging will minimize unnecessarily abrupt changes in the level of power supplied to the drive means, and will minimize the extent to which a single cycle that happens to be very different from the cycles that preceded it and from the cycles that followed it would unnecessarily cause changes in the control decisions.

The method according to this example is implemented on the equipment described above. When cleaning the surfaces of abrasive polished items, whereby the used abrasive, including dirt from the cleaned items falls through and collects on the rake conveyors 75,76, which are located under the grille forming the floor of the workstation. By return motion of the rakes 752,762, the used abrasive, including the dirt removed from the surface of the cleaned item is gradually moved onto a bucket conveyor, which transports it for cleaning and recycling. The rakes 752,762 of each of the rake conveyors 75,76 are suspended on moving parts 751,761, which by back and the forth action of the moving parts 12,22,32,42 of drive units 1,2,3,4 move in linear back and forth motion to and from the bucket conveyor. The moving parts 751,761 of rake conveyors 75,76 moves concurrently moving parts 12,22,32,42 of the drive units 1,2,3,4 from one dead point (limit of travel) to the next. Sensors 71,72,73,74 in the presence of magnetic pistons 112 and 322 are activated near them. Sensors 71,72,73,74 indicate presence of indication points 19,39 near the sensors 71,72,73,74. This information is transmitted to control unit 5, which measures and records the length of the time intervals between the individual cycles of pistons 112 and 322 through the terminal positions of moving parts 12,22,32,42 of drive units 1,2,3,4. The instantaneous speed of the raking action depends on the momentary load of the rake conveyor 75,76 and the momentary input of the drive unit 1,2,3,4. At constant power input of the drive unit 1,2,3,4, increasing of the volume of transported abrasive leads to increasing of load on the rake conveyor 75,76. This results to elongation of the time between the individual piston cycles, such that the output of the rake conveyor 75,76 declines. Control unit 5 controls the input of the drive units 1,2,3,4 in cycles. As a variable, which serves to determine the essential input in the next cycle, the time essential for moving parts 12, 22, 32, 42 of the drive unit 1, 2, 3, 4 or moving part 75, 76 of the equipment, which is the moving part of the drive unit 1,2,3,4 in mechanical contact, for change of position from one predefined position to another predefined position is used. In this embodiment, this concerns moving parts 751,761 of rake conveyors 75,76. This time is the measure of the load of the rake conveyor 75,76 in the present cycle or in one of the preceding cycles. One cycle may include both transition of the piston 112,322 from one dead centre (limit of travel) to another, also the time interval for execution of several return motions of the rakes. If the sensors are not located at the dead centres, it is possible to monitor the time essential for partial shift of the pistons and in a case where the several sensors are installed on one drive unit, the piston motion from one dead centre to another can even entail several cycles of the control unit. The input of drive units 1,2,3,4 can thus dynamically changed also within the framework of a single cycle. Control unit 5 controls the input of the drive units 1, 2, 3, 4 by control of direction and gas flow time at constant pressure at the input and gradual or alternating connection of the drive units to the gas sources with varying pressures at the outputs. The input can be controlled also by interruption of the gas supply to the drive units 1,2,3,4. When interrupting the gas supply to the drive units 1,2,3,4 in course of piston motion, the gas may expand and move pistons 112,222,322,422 until the pressure is balanced with the resistance, which the rake conveyor generates for the piston. For better control, data is also transmitted to the control units 5 about the momentary pressure in the individual parts of the piping, which is measured using pressure sensors 94,96,97,98. To determine the input of the drive unit 1, 2, 3, 4 for the next cycle, it is thus possible to use information about momentary pressures in the preceding cycle or also in course of the current cycle.

### Example 2

The connection according to this example differs from the connection described in example 1 in that it does not apply to equipment that has only one drive unit 1, which is a hydraulic linear drive, in that it has only one power source 91, which is the source of hydraulic fluid, in that the regulating and/or switching element 61 consists of the actual regulating element 614, which regulates only the flow of the hydraulic fluid through the pipe and from the autonomous switching element 611, which determines the flow direction of the hydraulic fluid. The embodiment according to example 2 further differs from the embodiment described in example 1 in that the load ratio of the rake conveyor 75 is derived from the speed of the moving parts 751 of the rake conveyor 75 (rather than from moving parts of the drive unit).

The reader will appreciate, therefore, that the benefits of the invention offer themselves just as well regardless of whether the time intervals are measured using a sensing arrangement that senses movement of moving parts of the drive unit, or whether the time intervals are measured using a sensing arrangement that senses movement of moving parts of the rake conveyor (the equipment that acts upon the material being conveyed).

The drive unit 1 consists of a dual action hydraulic linear motor and contains fixed part 11 and moving part 12, which are made up of piston 112 and piston rod 121. The fixed part 11 of drive unit 1 contains a hydraulic cylinder with two inputs/outputs 13, 14, which are at opposite ends of the piston 112 of the drive unit 1. Piston rod 121 is connected to the moving part 751 of the rake conveyor 75. One of the edges of the moving part 751 of the rake conveyor 75 is the first indicating point 19 for indication of the position of the moving part 751 of the rake conveyor 75, while the opposite edge of the moving part 751 of the rake conveyor 75 is the second indicating point 39 for indication of the position of the moving part 751 of the rake conveyor 75. Close to the opposite ends of the moving part 751 of the rake conveyor 75 are sensors 71,72, whose mutual distance is larger than the distance of the opposite edges of the moving part 751 of the rake conveyor 75. The first position sensor 71 is used to indicate the presence of the first indication point 19 at first dead centre. The second position sensor 72 is used to indicate the presence of the second indication point 39 at second dead centre. Each of the sensors 71,72 has an output 711,721. Both sensors 71,72 are capable of detecting the presence of ferromagnetic metal in their vicinity. The equipment further contains one power source 91, which is the source of hydraulic fluid. In the connection, the inputs/outputs 13,14 are fixed parts of drive unit 1 connected to power source 91, via the regulating and/or switching element 61. The regulating and/or switching element 61 consist of the actual regulating element 614 and autonomous switching element 611. The switching element 611 contains input 652 and output 651, two inputs/outputs 612,613 and the control input 63. Input 65 of the first regulating and/or switching element 61 is connected to the output 93 of the power source 91, in this case to the hydraulic fluid output. The output 615 of the first regulating and/or switching element 61 is connected to the input 652 of the switching element 611. Output 651 of the switching element 611 is connected to the input 931 of power source 91, in this case being an exit path for the hydraulic fluid expelled from drive unit 1. The first input/output 612 of the switching element 611 is connected to the first input/output 13 of the control unit 1. The second output 613 of the switching element 611 is connected to the second input/output 14 of the drive unit 1. The first pressure sensor 94 is in the section of the pipe, which connects the output 93 of the power source 91 to the input of the regulating element 614. The second pressure sensor 96 is in the section of the pipe, which connects the output 615 of the regulating element 614 to the input 652 of the switching element 611. Both pressure sensors 94,96 are further connected to control unit 5. The first pressure sensor 94 is connected to the third input 53 of the control unit 5 and second pressure sensor 96 is connected to the fourth input 54 of the control unit 5. Output 711 of the first sensor 71 of the first indicating point 19 is connected with the first input 51 of the control unit 5 and output 721 of the second sensor 72 of the second indicating point 39 is connected with the second input 52 of the control unit 5. Control unit 5 further contains the first control output 55, connected with control input 631 of the switching element 611, the second control output 56, connected with control input 632 of the regulating element 614 and the third control output 57 is connected with control input 932 of the power source 91.

The method according to this example differs from the method described in example 1 in that instead of the possibility to regulate the input of the drive unit by switching between power sources 91,92 with varying output pressure, there is a possibility here to regulate the input of the drive unit by means of hydraulic fluid flow and pressure. The moving part 751 of the rake conveyor 75 upon return motion alternately gets within reach of the first sensor 71 or the second sensor 72. Information about the presence of a moving part 751 of the rake conveyor 75 within detection of distance of sensor 71,72 is transmitted to the control unit 5, which measures the recorded time intervals between the individual passes of the moving part 751 of the rake conveyor 75 through the terminal positions. Also transmitted to the control unit 5 is information about the actual pressure in the hydraulic pipe before the input of the hydraulic fluid to the regulating element 614 and before the input to the switching element 611. This information is processed by control unit 5 identically as described in example 1. Control unit 5 controls the input of the drive unit in cycles, as described in example 1, whereby it controls both the hydraulic fluid pressure and flow.

### Example 3

The apparatus according to example 3 differs from that described in example 2 in that drive unit 1 is a linear electric motor, regulating and/or switching element 61 consists of only one regulating element 614, which based on commands from control unit 5 controls the input of the drive unit by modification of the alternating current cycle and in that sensors 71 and 72 are optical and are located at the terminal ends of the moving part 12 of the drive unit 1, at which they confirm the presence or absence of the same indicating point 19. Between output 615 of regulating element 614 and an input 101 of the drive unit 11 there are an electric current sensor 961 and an electric voltage sensor 962. These sensors 961,962 are connected to control unit 5, which in the control of the drive unit 1 based on the duration of the time intervals between passage through the indicating point 19 between the first position sensor 71 and the second position sensor 72 are able to derive the momentary electrical resistance of the linear electric motor. Control unit 5 controls the input of the electric motor by regulating the size or frequency of the electric alternating current at the output of the power source 91 and thus through regulating element 614 it modifies the current cycle in the individual periods.

This example is described with respect to an alternating current motor, but of course the teachings of the invention could offer themselves just as well to (for example) a DC motor driven with pulse-width modulation.

### Example 4

The apparatus according to example 4 differs from the that described in example 3 in that it contains only one position sensor 71, which is a mechanical sensor that indicates contact with the first or second projection on the moving part of the rake conveyor, where one of the projections is the first indicating point 19 and the second is the second indicating point 39. Evaluation of the load of the rake conveyor 75 based on the length of the time intervals between the individual passes of the moving parts of the rake conveyor 75 is analogous to what was described in the previous cases in that the difference when setting the required input for the next cycle also takes the momentary electric resistance of the linear electric motor into consideration.

### INDUSTRIAL APPLICABILITY

The invention can be applied to equipment that require guarantee of smooth operation even in conditions when they are exposed to varying loads, not only in cases where such equipment is equipped with linear drive units, but also in cases where rotary drives are used. The sensors used for indication of the position of the moving part, whose motion is detected may be, for instance, contact, magnetic or optical.

1. A method for use with a drive unit connected to a load, where the drive unit consists of a fixed part and moving part and is connected by an input to a power source, the moving part of the drive unit connected to a moving part of equipment acting upon the load, the load having a magnitude changing from time to time, wherein the output of the drive unit is controlled in repeated cycles, the method comprising the steps of:
during at least one first cycle, measuring a time period required for changing a position of the moving part of the drive unit, or for changing a position of a moving part of the equipment which is in mechanical contact with the moving part of the drive unit, from one predefined position to another predefined position, and
during a second cycle after the at least one first cycle, determining the input for the drive unit according to the time period ascertained in the at least one first cycle.

2. The method according to claim 1, wherein the drive unit is a pneumatically controlled drive unit and the power source is a gas source providing driving gas, and wherein the determination of the input for the drive unit comprises controlling by regulation of the flow and/or selection of pressure of driving gas, used for the pneumatically controlled drive unit.

3. The method according to claim 1, wherein the drive unit is a hydraulically controlled drive unit and the power source is a hydraulic pump providing pressure tending to cause flow of hydraulic fluid, and wherein the determination of the input for the drive unit comprises controlling by regulation of the flow of the hydraulic fluid and/or by pressure acting on the hydraulic fluid.

4. The method according to claim 2, wherein the pneumatically controlled drive unit has a cylinder and piston, and the step of measuring during at least one first cycle further comprises ascertaining the pressure of the gas, at at least at one point between the gas source and the piston of the drive unit, and wherein the step of determining the input for the drive unit is also determined based on the pressure ascertained in the at least one first cycle.

5. The method according to claim 3, wherein the hydraulically controlled drive unit has a cylinder and a piston, and the step of measuring during at least one first cycle further comprises ascertaining the pressure of the hydraulic fluid, at at least at one point between the hydraulic fluid source and the piston of the drive unit, and wherein the input of the drive unit is also determined based on the pressure ascertained in the at least one first cycle.

6. The method according to claim 1, wherein the drive unit is an electric motor having electric resistance, and the step of measuring during at least one first cycle further comprises ascertaining the electric resistance of the electric motor, and wherein the input of the electric motor is also set based on the electric resistance of the electric motor ascertained in the at least one first cycle.

7. The method according to claim 1 wherein the step of determining the input for the drive unit according to the time period ascertained in the at least one first cycle comprises choosing a larger input when the time period ascertained is longer and choosing a smaller input when the time period ascertained is shorter.

8. The method according to claim 7 wherein the choice of input is based upon an average of ascertained time periods during several first cycles.

9. Apparatus comprising equipment operating upon material in cycles, a drive unit having an output connected to a changing load, the drive unit consisting of a fixed part and a moving part and at least one input/output, the moving part of the drive unit connected with a moving part of the equipment, the moving part of the equipment operating upon the material in the cycles, the input/output connected via a regulating and/or switching element to at least one power source, the regulating and/or switching element having a control input, the apparatus further comprising a control unit having a control output connected to the control input of the regulating and/or switching element, the apparatus having a sensor arrangement for sensing progress of the moving part of the drive unit or of the moving part of the equipment through the cycles, the sensor arrangement having an output connected to an input of the control unit, the control unit disposed to control the regulating and/or switching element during a cycle in response to sensed cycle times of movement of the moving part of the drive unit or of the moving part of the equipment through the cycles.

10. The apparatus according to claim 9, wherein the power source is a source of compressed gas and the drive unit is a pneumatic drive unit, and the regulating and/or switching element regulates pressure of the compressed gas.

11. The apparatus according to claim 9, wherein the power source is a hydraulic fluid pump, and the drive unit is a hydraulic drive unit.

12. The apparatus according to claim 9, wherein the power source is a source of electric power and the drive unit is an electric motor.

13. The apparatus according to claim 10, wherein a pipe connects the power source to the input/output of the drive unit, the apparatus further comprising at least one pressure sensor at the pipe, the pressure sensor having an output connected to the control unit.

14. The apparatus according to claim 11, wherein a pipe connects the power source to the input/output of the drive unit, the apparatus further comprising at least one pressure sensor at the pipe, the pressure sensor having an output connected to the control unit.

15. The apparatus according to claim 9, the power source comprising at least first and second power sources, the regulating and/or switching element selecting among the at least first and second power sources and connecting the selected power source among the at least first and second power sources to the drive unit, the control unit connected to the regulating and/or switching element so as to control the selection among the at least first and second power sources.

16. The apparatus according to claim 9 wherein the control means determines the input for the drive unit by controlling the regulating and/or switching element according to the time period ascertained in the at least one first cycle by choosing a larger input when the time period ascertained is longer and choosing a smaller input when the time period ascertained is shorter.

17. The apparatus according to claim 16 wherein the choice of input is based upon an average of ascertained time periods during several first cycles.
